(19) United States
(12) Patent Application Publication
(10) Pub. No.: US 2026/0323519 A1
(43) Pub. Date: Oct. 15, 2026

(54) User Equipment Wakeup Signal Triggering On-Demand SSB/SIB1

(71) Applicant: Apple Inc., CUPERTINO, CA (US)

(72) Inventors: Dan WU, Beijing (CN); Dawei ZHANG, Saratoga, CA (US); Hong HE, San Jose, CA (US); Peng CHENG, Beijing (CN); Seyed Ali Akbar FAKOORIAN, San Diego, CA (US); Sigen YE, San Diego, CA (US); Wei ZENG, Saratoga, CA (US)

(21) Appl. No.: 18/870,503

(22) PCT Filed: Dec. 1, 2023
(86) PCT No.: PCT/CN2023/135889

§ 371 Date: Nov. 29, 2024

(51) Int. Cl. H04W 52/02; H04L 5/00

(52) U.S. Cl. CPC H04W 52/0235; H04L 5/0053

(57) ABSTRACT

A user equipment (UE) configured to decode, based on signals received from a base station, configuration information comprising (i) an indication that the base station is not transmitting System Information Block 1 (SIB1) information and (ii) wakeup signal (WUS) configuration information indicating information for sending a WUS to trigger the base station to transmit SIB1 information, configure transceiver circuitry to transmit the WUS to the base station according to the WUS configuration information and monitor for SIB1 information transmitted from the base station.

### TECHNICAL FIELD

The present disclosure generally relates to wireless communication, and in particular, to user equipment wakeup signal triggering on-demand SSB/SIB1.

### BACKGROUND

Network energy saving (NES) is a mode of operation for New Radio (NR) which reduces signaling and power draw at a base station of the network. NES typically involves a base station muting certain transmissions such as reference signals (RSs) and/or System Information Block (SIB) signals. In one example of a RS, a Synchronization Signal Block (SSB) is an RS transmitted by a base station and used by a user equipment (UE) for time and frequency synchronization with the cell. In another example, SIB1 includes information that the UE may use when determining whether the UE is allowed to access a cell. Thus, muting of such base station signals may result in the UE not being able to access the base station. However, it would be beneficial for power saving if a base station could operate in NES mode while still allowing for a UE to access the base station when needed.

### SUMMARY

Some example embodiments are related to an apparatus of a user equipment (UE), the apparatus including processing circuitry configured to decode, based on signals received from a base station, configuration information comprising (i) an indication that the base station is not transmitting System Information Block 1 (SIB1) information and (ii) wakeup signal (WUS) configuration information indicating information for sending a WUS to trigger the base station to transmit SIB1 information, configure transceiver circuitry to transmit the WUS to the base station according to the WUS configuration information and monitor for SIB1 information transmitted from the base station.

Other example embodiments are related to an apparatus of a base station, the apparatus including processing circuitry configured to configure transceiver circuitry to transmit configuration information to a user equipment (UE) comprising (i) an indication that the base station is not transmitting System Information Block 1 (SIB1) information and (ii) wakeup signal (WUS) configuration information indicating information for sending a WUS to trigger the base station to transmit SIB1 information, decode, based on signals received from the UE, the WUS and configure transceiver circuitry to transmit SIB1 information.

### BRIEF DESCRIPTION OF THE DRAWINGS

FIG. 1 shows an example network arrangement according to various example embodiments.

FIG. 2 shows an example user equipment (UE) according to various example embodiments.

FIG. 3 shows an example base station according to various example embodiments.

FIG. 4 shows an example method that provides a general overview of a UE triggering an NES cell to transmit on-demand SSB and/or SIB 1 according to various example embodiments.

FIG. 5 shows an example of a master information block (MIB) of a PBCH payload for an SSB transmitted by an NES cell according to various example embodiments.

FIG. 6 shows a timing and frequency diagram illustrating an example of SSB timing and frequency resources and wakeup signal (WUS) timing and frequency resources according to various example embodiments.

FIG. 7 shows an example configuration table for WUS configuration information according to various example embodiments.

FIG. 8 shows a timing and frequency diagram illustrating a first example of a SIB1 monitoring window according to various example embodiments.

FIG. 9 shows a timing and frequency diagram illustrating a second example of a SIB1 monitoring window according to various example embodiments.

### DETAILED DESCRIPTION

The example embodiments may be further understood with reference to the following description and the related appended drawings, wherein like elements are provided with the same reference numerals. The example embodiments relate to a user equipment (UE) sending a wakeup signal (WUS) to cause a network cell that is operating in NES mode to start transmitting SSBs and/or SIB1.

The example embodiments are described with regard to a UE. However, reference to a UE is merely provided for illustrative purposes. The example embodiments may be utilized with any electronic component that may establish a connection to an accessory device and is configured with the hardware, software, and/or firmware to exchange information and data with accessory devices. Therefore, the UE as described herein is used to represent any electronic component.

The example embodiments are also described with reference to a 5G New Radio (NR) network. However, the example embodiments may also be implemented in other types of networks, including but not limited to LTE networks, future evolutions of the cellular protocol (e.g., 5G-advanced networks, 6G networks, etc.), or any other type of network.

As stated above, a network cell operating in NES mode may not transmit SSBs or SIB1. In some cases, the network cell may transmit SSBs but these SSBs may be simplified SSBs that do not include all the information normally included in SSBs and/or the SSBs may be transmitted at a periodicity that is larger than a standard periodicity for SSBs. The exact operations of a network cell operating in NES mode may be defined by standards such as the 3GPP Technical Specifications. The example embodiments may be implemented for network cells that operate in any type of power saving mode. In addition, throughout this description, network cells operating in NES mode may be referred to as NES cells. These network cells may transition out of NES mode when receiving the WUS from the UE but will be continued to be referred to as an NES cell in the description.

When a network cell is operating in NES mode, there may be two scenarios for a UE to send a WUS to the network. In a first scenario, the UE may send the uplink (UL) WUS to the network cell that the UE wants to trigger to start transmitting SSBs and/or SIB1, e.g., the WUS is sent directly to the network cell operating in NES mode. This scenario is termed a “single carrier” scenario. In a second scenario, the UE may send the UL WUS to a cell that is associated with the network cell that that the UE wants to trigger to start transmitting SSBs and/or SIB1. For example, in a carrier aggregation (CA) scenario, the UE may send the UL WUS to a primary cell (PCell) to indicate that the UE wants a secondary cell (SCell) of the CA combination to transmit SSBs or SIB1. This scenario is termed a “multi-carrier” scenario. The example embodiments are generally related to the first scenario, e.g., the single carrier scenario.

In the single carrier scenario, the NES cell may not transmit the SIB1 and only a simplified SSB or an SSB with a periodicity larger than 20 ms may be transmitted. However, in the single carrier scenario, the cell operating in NES mode may be found by an NES-capable UE as a camping carrier/cell. Thus, the UE may search and find the NES cell and attempt to access the NES cell based on cell selection/reselection criteria. Since no SIB1 will be available on the NES cell, the UE may not access the NES cell because the SIB1 includes the information that the UE uses to access the cell, e.g., the UE only has Master Information Block (MIB) information that is indicated in the SSB and this MIB information is not enough for cell access.

The example embodiments provide the UE with a configuration that allows the UE to send a WUS to the NES cell that to trigger the normal SSB transmission, or a SIB1 transmission, for the UE to obtain enough configuration information to access the NES cell. This may be referred to as the UE triggering an on-demand SSB or SIB1 transmission by the NES cell. This configuration also provides the UE with the configuration information for transmitting the WUS. For example, where the UE may find the WUS configuration and the type of information indicated in the WUS. Furthermore, the example embodiments also describe the UE behavior after sending the UL WUS. Each of these example embodiments will be described in greater detail below.

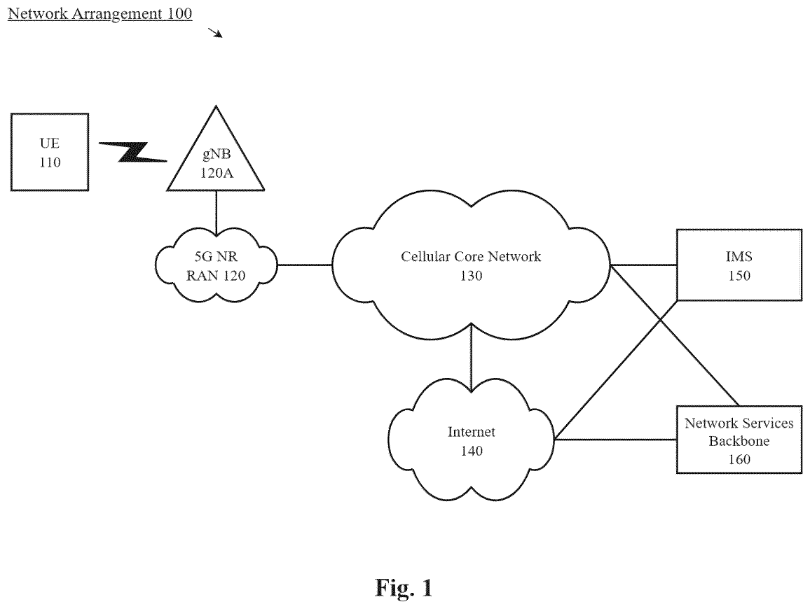

FIG. 1 shows an example network arrangement 100 according to various example embodiments. The example network arrangement 100 includes a UE 110. The UE 110 may be any type of electronic component that is configured to communicate via a network, e.g., mobile phones, tablet computers, desktop computers, smartphones, embedded devices, wearables, Internet of Things (IoT) devices, etc. An actual network arrangement may include any number of UEs being used by any number of users. Thus, the example of one UE 110 is merely provided for illustrative purposes.

The UE 110 may be configured to communicate with one or more networks. In the example of the network arrangement 100, the network with which the UE 110 may wirelessly communicate is a 5G NR radio access network (RAN) 120. The UE 110 may also communicate with other types of networks (e.g., 5G cloud RAN, a next generation RAN (NG-RAN), a legacy cellular network, etc.) and the UE 110 may also communicate with networks over a wired connection. With regard to the example embodiments, the UE 110 may establish a connection with the 5G NR RAN 120. Therefore, the UE 110 may have a 5G NR chipset to communicate with the NR RAN 120.

The 5G NR RAN 120 may be portions of a cellular network that may be deployed by a network carrier (e.g., Verizon, AT&T, T-Mobile, etc.). The RAN 120 may include cells or base stations that are configured to send and receive traffic from UEs that are equipped with the appropriate cellular chip set. In this example, the 5G NR RAN 120 includes the gNB 120A and the gNB 120B. However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.).

Any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., gNB 120A).

The network arrangement 100 also includes a cellular core network 130, the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

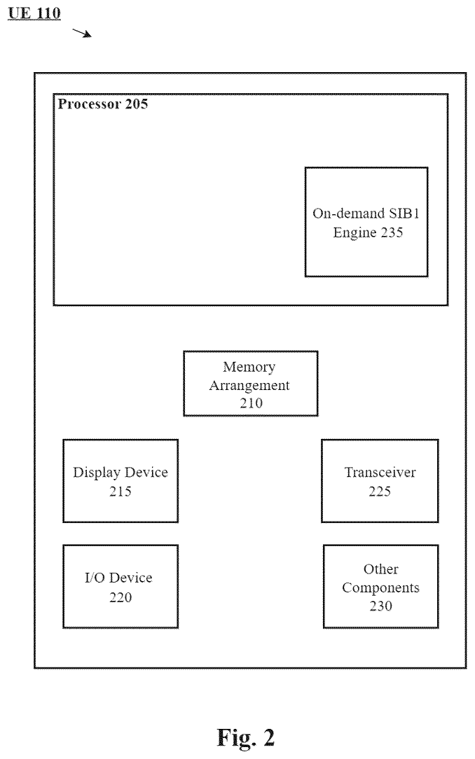

FIG. 2 shows an example UE 110 according to various example embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include an on-demand SIB1 engine 235 for performing operations related to triggering an on-demand SIB1 transmission from a base station operating in NES mode. The operations include, but are not limited to, determining the base station is operating in SIB1-less NES mode, determining a configuration to transmit a WUS to the base station to trigger SIB1 transmissions, transmitting the WUS and monitoring for the SIB1 information after transmitting the WUS. Each of these example operations will be described in more detail below.

The above referenced engine being an application (e.g., a program) executed by the processor 205 is only example. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs.

The display device 215 and the I/O device 220 may be separate components or integrated together such as a touchscreen.

The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

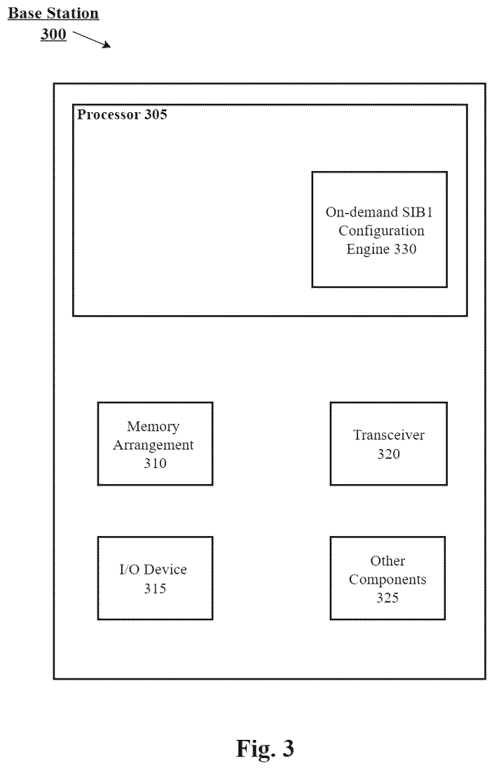

FIG. 3 shows an example base station 300 according to various example embodiments. The base station 300 may represent the gNB 120A, the gNB 120B or any other access node through which the UE 110 may establish a connection and manage network operations.

The base station 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power sources, etc.

### The Processor 305 May Be Configured to Execute a

plurality of engines for the UE 110. For example, the engines may include an on-demand SIB1 configuration engine 330 for performing operations related to configuring a UE to trigger on-demand SIB1 transmissions. The operations include, but are not limited to, indicating to the UE that the base station 300 is operating in SIB1-less NES mode, configuring the UE to transmit a WUS to the base station 300 to trigger SIB1 transmissions, receiving the WUS and transmitting the SIB1 information in response to receiving the WUS. Each of these example operations will be described in more detail below.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100.

The transceiver 320 may be a hardware component configured to exchange data with the UE 110 and any other UE in the network arrangement 100. The transceiver 320 may operate on a variety of different frequencies or channels (e.g., set of consecutive frequencies). The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described here.

Throughout this description, the terms on-demand SSB or on-demand SIB1 transmissions may be used interchangeably to describe any transmissions/broadcasts by a base station that include SIB1 information. These on-demand SSB or on-demand SIB1 transmissions may include, but are not limited to, normal SSB transmissions that have SIB1 information, SIB1 transmissions, or partial SIB1 transmissions that include some SIB1 information but not all the information normally included in a SIB1 transmission. For example, in some example embodiments the partial SIB1 transmissions may only include SIB1 information that has changed since a previous SIB1 transmission.

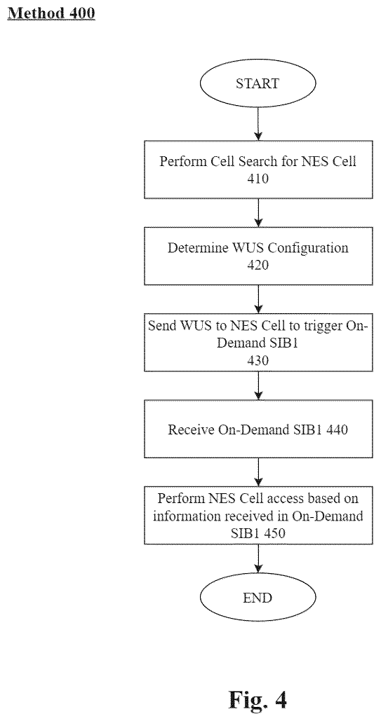

FIG. 4 shows an example method 400 that provides a general overview of a UE triggering an NES cell to transmit on-demand SSB and/or SIB1 according to various example embodiments. The method 400 may be performed by the UE 110 attempting to access the base station 300 (e.g., qNB 120A) that is operating in NES mode. As will be described below, the base station 300 operating in NES mode may be transmitting SSBs but these SSBs may not have an associated SIB1. The WUS transmitted by the UE 110 may trigger the base station to transmit SSBs that have associated SIB1 information. Thus, throughout this description, the SSBs that are triggered by the WUS and include associated SIB1 information are referred to as on-demand SSBs to be distinguish from the SSBs without associated SIB1 information that are transmitted by the base station when in NES mode.

In 410, the UE 110 may perform a cell search and identify the base station 300 as a cell that the UE 110 may attempt to access. The base station 300 may be operating in NES mode, e.g., is an NES cell. When performing the cell search, the UE 110 may consider that the base station 300 is transmitting a normal 4-symbol SSB structure as defined by the current cellular standards (e.g., 3GPP Technical Specifications). This normal 4-symbol SSB structure comprises a Primary Synchronization Signal (PSS), a Secondary Synchronization Signal (SSS) and a Physical Broadcast channel (PBCH) that is transmitted with a 20 ms SSB periodicity. As will be described in greater detail below, the UE 110 may determine the base station 300 is operating in NES mode because the SSBs transmitted by the base station 300 may not have an associated SIB1.

When the UE 110 determines that there is no associated SIB1, in 420, the UE 110 will determine the WUS configuration that allows the UE 110 to send a WUS to trigger on-demand SSB or SIB1 transmissions. As will be described in greater detail below, this WUS configuration may be indicated in the SSBs transmitted by the base station in NES mode.

In 430, the UE 110 sends the WUS to the base station using the WUS configuration determined in 420. The transmission of the WUS signal may reuse the Physical Random Access Channel (PRACH) preambles.

In 440, the UE may receive the on-demand SSBs or SIB1 that include the information the UE 110 uses to access the base station 300. In 450, the UE 110 may use the SIB1 information to access the base station 300.

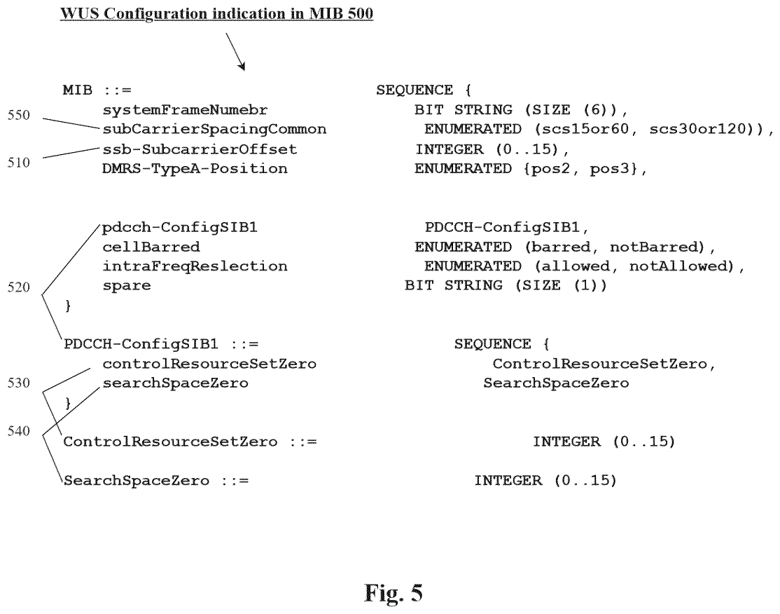

FIG. 5 shows an example of a master information block (MIB) 500 of a PBCH payload for an SSB transmitted by an NES cell according to various example embodiments. When the base station 300 is operating in NES mode, the SSBs that are transmitted by the base station 300 may include the MIB 500 and physical layer (PHY) information (not shown).

The MIB 500 may be considered to be payload that is generated by the higher layers and the fields shown in FIG. 5 are the MIB fields as defined in the 3GPP Technical Specification 38.331. However, there is no requirement that the currently defined MIB fields be used in the example embodiments.

The PHY information (not shown) may comprise eight (8) bits but there is no requirement that the PHY information be this size. In this example, the four (4) least significant bits (LSB) of the PHY information (e.g., a_{A}, a_{A+1}, a_{A+2}, a_{A+3}) may signal a system frame number (SFN). Another bit (e.g., a_{A+4}) may signal a half radio frame indication. For frequency range 2 (FR2), the three (3) most significant bits (MSB) of the PHY information (e.g., a_{A+5}, a_{A+6}, a_{A+7}) may signal an SSB index. For frequency range 1 (FR1) the MSB (e.g., a_{A+5}) may signal the SSB subcarrier offset. In FR1, the remaining MSBs of the PHY information may be reserved.

The PBCH payload of the SSB transmitted by the base station 300 in NES mode may provide the UE 110 with the information that the base station 300 is operating in NES mode, supports on-demand SSB and/or SIB1 and the WUS configuration for triggering the on-demand SSB and/or SIB1.

For example, the ssb-SubcarrierOffset field 510 may be a 4 bit field of the MIB 500. The ssb-SubcarrierOffset corresponds to the parameter k_{SSB} that is defined in 3GPP Technical Specification 38.213 as the frequency domain offset between the SSB and the overall resource block grid in a number of subcarriers. The four (4) LSB of k_{SSB} may be indicated by the ssb-SubcarrierOffset field 510.

For example, for FR1, the k_{SSB} may have a value range 0<=L_{SSB}<=31. Thus, 5 bits may be used to signal the 32 codepoints associated with k_{SSB} for FR1. The MSB of the k_{SSB} may be indicated by the MSB (e.g., a_{A+5}) of the PBCH payload as described above while the four (4) LSB may be indicated by the ssb-SubcarrierOffset field 510. In this example, it may be considered that a codepoint value k_{SSB}=30 signals to the UE 110 that the base station 300 is operating in NES mode, e.g., the base station 300 is not currently transmitting SIB1 information. This codepoint value may also indicate to the UE 110 that the base station 300 is capable of on-demand SSB or SIB1 when in NES mode and may cause the UE 110 to determine the WUS configuration information for triggering the on-demand SSB or SIB1. This determining of the WUS configuration information will be described below after the FR2 example. The use of the codepoint value k_{SSB}=30 is only an example and any of the other 31 values of k_{SSB} for FR1 may be used to signal the base station is operating in NES mode.

In the example of FR2, the k_{SSB} may have a value range 0<=k_{SSB}<=15. Thus, 4 bits may be used to signal the 16 codepoints associated with k_{SSB} for FR2. This means the 4 bits of the ssb-SubcarrierOffset field 510 may indicate the k_{SSB} for FR2. In this example, it may be considered that a codepoint value k_{SSB}=14 signals to the UE 110 that the base station 300 is operating in NES mode, e.g., the base station 300 is not currently transmitting SIB1 information. This codepoint value may also indicate to the UE 110 that the base station 300 is capable of on-demand SSB or SIB1 when in NES mode and may cause the UE 110 to determine the WUS configuration information for triggering the on-demand SSB or SIB1. The use of the codepoint value k_{SSB}=14 is only an example and any of the other 15 values of k_{SSB} for FR2 may be used to signal the base station is operating in NES mode.

As described above, when the UE 110 determines the base station 300 is operating in NES mode and is capable of on-demand SSB or SIB1 transmission (e.g., based on the codepoint value of k_{SSB}), the UE 110 may then determine the WUS configuration to trigger the on-demand SSB or SIB1. Referring to FIG. 5, the MIB 500 also includes a pdcch-ConfigSIB1 field 520. Since the base station 300 is not transmitting SIB1 information when in NES mode, the pdcch-ConfigSIB1 field 520 would not carry any useful information when in this mode, e.g., the base station is not transmitting Control Resource Set (CORESET) #0 information corresponding to the SIB1. Thus, the pdcchConfigSIB1 field 520 may be reinterpreted by the UE 110 when the base station 300 is operating in NES mode. As shown in FIG. 5, the pdcch-ConfigSIB1 field 520 comprises two fields, a ControlResourceSetZero field 530 having 4 bits and a SearchSpaceZero field 540 having 4 bits for a total of 8 bits in the pdcch-ConfigSIB1 field 520. These 8 bits may be used to indicate the WUS configuration to trigger the on-demand SSB or SIB1.

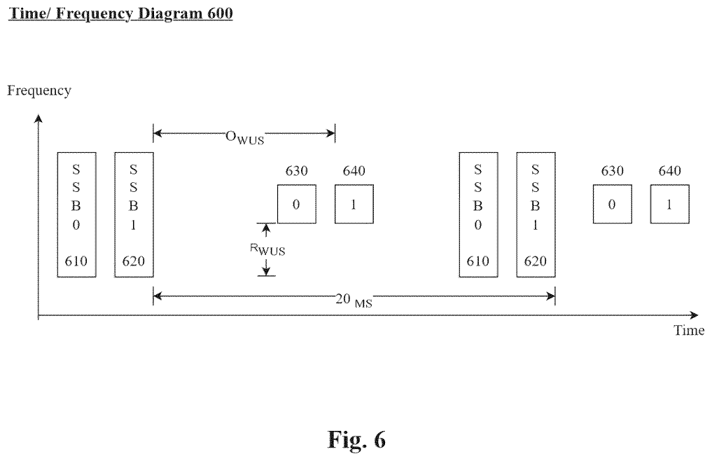

The following provides example information that may be indicated in the WUS configuration, e.g., in the 8 bits of the pdcch-ConfigSIB1 field 520. Some of this example WUS configuration information will be described with reference to FIG. 6. The WUS configuration information described below is only an example as the WUS configuration information may include some or all of the examples or further information in addition to the examples.

FIG. 6 shows a timing and frequency diagram 600 illustrating an example of SSB timing and frequency resources and WUS timing and frequency resources according to various example embodiments. In this example, the base station 300 operating in NES mode may be transmitting SSBs (e.g., SSB0 610 and SSB 1 620) at a periodicity of 20 ms as shown in FIG. 6. The SSB0 610 and SSB1 620 are SIB1-less SSBs because the base station 300 is in NES mode.

In a first example of WUS configuration information, a timing offset WUS of the WUS resource associated with the detected SSB may be configured. In the example of FIG. 6, the UE 110 may detect the first SSB1 620 and the pdcch-ConfigSIB1 field 520 of the SSB1 620 may include a value for the timing offset O_{WUS} as shown in FIG. 6. This means that the UE 110 should transmit the WUS at a time corresponding to the end of the SSB1 620 transmission+O_{WUS} as shown by WUS resource 1 640 in FIG. 6.

In this example, the periodicity of the WUS resource may be the same as SSB periodicity (e.g., 20 ms) and does not need to be signaled as part of the WUS configuration information. For example, in FIG. 6 the second WUS resource 1 640 occurs 20 ms after the first WUS resource 1 640. However, in some example embodiments, the WUS configuration information may include a periodicity for the WUS resources. The subcarrier spacing (SCS) used to indicate the timing offset O_{WUS} may be configured in the subCarrierSpacingCommon field 550 in the MIB 500 as shown in FIG. 5.

In a second example of WUS configuration information, a frequency offset R_{WUS} of the WUS resource and the detected SSB may be configured. In the example of FIG. 6, the UE 110 may detect the first SSB0 610 and the pdcch-ConfigSIB1 field 520 of the SSB1 610 may include a value for the frequency offset R_{WUS} as shown in FIG. 6. In some examples, the frequency offset R_{WUS} may be indicated in terms of Physical Resource Blocks (PRBs). This means that the UE 110 should transmit the WUS at a frequency corresponding to the lowest PRB frequency of the SSB0 610 transmission+R_{WUS} as shown by WUS resource 0 630 in FIG. 6.

In the example of FIG. 6, the frequency offset R_{WUS} is determined from the lowest PRB. In other example embodiments, frequency offset R_{WUS} may be applied from a different PRB of the SSB, e.g., a center PRB. Similar to the timing offset O_{WUS}, the SCS used to indicate the frequency offset R_{WUS} may be configured in the subCarrierSpacingCommon field 550 in the MIB 500 as shown in FIG. 5.

In some example embodiments, the frequency offset R_{WUS} may be omitted from the WUS configuration information as the UE 110 may make certain assumptions regarding the WUS configuration and the frequency of the WUS resource. For example, the UE 110 may consider the WUS is to be transmitted at a fixed frequency that corresponds to the detected SSB frequency, e.g., the lowest PRB of the WUS and the detected SSB are aligned, the highest PRB of the WUS and the detected SSB are aligned, etc. In another example, the PRB center of the WUS and the detected SSB are aligned. Thus, in these examples, the UE 110 may be preconfigured with information indicating the frequency offset R_{WUS} information for the WUS resource and this may reduce signaling overhead when signaling the WUS configuration information.

In a third example of WUS configuration information, WUS preamble information may be configured. The WUS preamble information may include a preamble format, a total number of WUS preambles and a root sequence index and cyclic shift for the WUS preambles. Examples of each of these will be provided below.

In some example embodiments, the preamble formats for FR1 and FR2 may be fixed. For example, FR1 may be Format 0 and FR2 may be Format B4. In these example embodiments, the WUS configuration information may not need to include the preamble formats because the UE 110 may be preconfigured with this WUS preamble format information based on information hard coded into the standards, e.g., 3GPP Technical Specifications.

In other example embodiments, a number of preamble formats may be listed, e.g., in a table indicated to the UE 110. For example, FRI may include Format 0/1 and FR2 may include Format B4/B1. Thus, the WUS configuration information may include bits that are set to indicate the one of the listed formats that should be used for the WUS. For the preamble SCS for FR2, the same SCS as configured in the subCarrierSpacingCommon field 550 in the MIB 500 as shown in FIG. 5 may be used.

In some example embodiments, the number of WUS preambles may be preconfigured to be 1. For example, when the UE 110 sends the WUS to the base station 300, the base station 300 does not need to distinguish UEs, e.g., since the WUS is triggering the base station 300 to transmit the on-demand SSB or SIB1, the base station 300 does not need to know the identity of the UE 110 triggering the broadcast. Thus, the same preamble sequence may be used by all UEs in the cell to trigger the on-demand SSB or SIB1. In this case, the number of WUS preambles may be hard coded into the standards, e.g., 3GPP Technical Specifications.

In other example embodiments, the number of WUS preambles may be included in the WUS configuration information. These example embodiments may be used when the UE 110 is configured to provide different types of triggering information. For example, the UE 110 may want to trigger a SIB1, a normal SSB, or a partial SIB1 (e.g., the UE 110 does not need all the SIB1 information but only select information from the SIB1). There may be different WUS preambles used to trigger these different types of broadcasts by the base station 300 and the WUS configuration information may indicate the number of preambles used to trigger these different types of broadcasts.

In some example embodiments, root sequence index and cyclic shift information may be indicated in the WUS configuration information. The root sequence index and cyclic shift information may be used to avoid neighboring cell false wake-up due to the UE 110 sending the WUS to the base station 300. For normal RACH preambles, there may be many combinations of root sequence index and cyclic shift. However, because the WUS configuration information is limited to 8 bits in this example, there may be a limited number of combinations of root sequence and cyclic shift values that may be configured, e.g., in a table indicated to the UE 110. Thus, the WUS configuration information may include bits that are set to indicate one of the configured root sequence index and cyclic shift that should be used for the WUS.

In a fourth example of WUS configuration information, a SIB1 monitoring window may be indicated. This field indicates a window length for the UE 110 to monitor for the CORESET #0 after the UE 110 sends the WUS.

In a fifth example of WUS configuration information, power settings for transmitting the WUS may be indicated. These power settings for the WUS transmission by the UE 110 may include values for SS-PBCH-BlockPower, preambleReceivedTargetPower and/or powerRampingStep. In some example embodiments, the UE 110 may be preconfigured to transmit the WUS using a maximum UE transmission power. In these example embodiments, the power settings may be omitted from the WUS configuration information because the UE 110 may transmit the WUS at a single power level, e.g., the maximum UE transmission power.

In a sixth example of WUS configuration information, a maximum number of WUS preamble transmissions may be configured. This field indicates the maximum number WUS preamble transmissions before UE 110 stops sending the WUS. Again, in some example embodiments this value may be hard coded into the standards, e.g., 3GPP Technical Specifications, and therefore may be omitted from the WUS configuration information.

As stated above, the above provided examples of WUS configuration information that may be transmitted as part of the pdcch-ConfigSIB1 field 520. However, as can be seen from the above examples, some of this WUS configuration information may be preconfigured in the UE 110 and may be omitted from the WUS configuration information that is transmitted as part of the pdcch-ConfigSIB1 field 520.

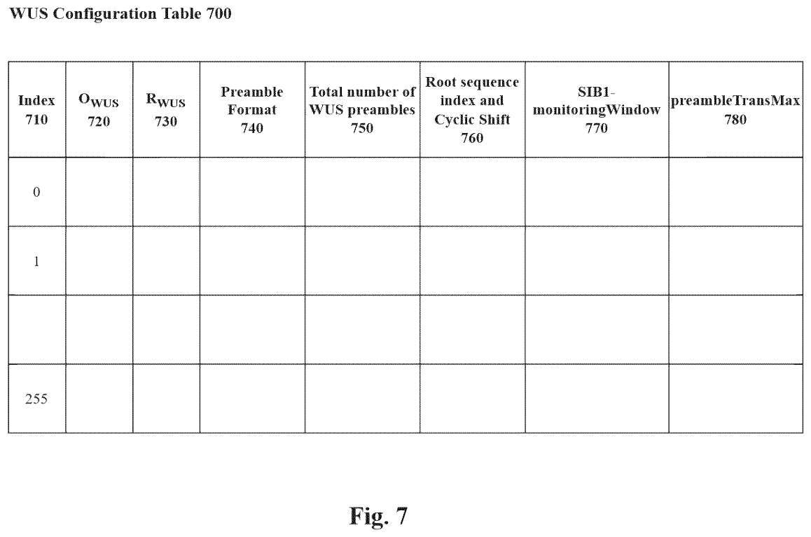

FIG. 7 shows an example WUS configuration table 700 for WUS configuration information according to various example embodiments. As described above, the pdcch-ConfigSIB1 field 520 may have 8 bits. From the above examples of the WUS configuration information it can be seen that there is a wide variety of WUS configuration information that may be indicated to the UE 110. There may be circumstances where the WUS configuration information that is to be indicated to the UE 110 may not fit within the 8 bits of the pdcch-ConfigSIB 1 field 520.

The WUS configuration table 700 may solve this issue of the limited number of bits in the pdcch-ConfigSIB1 field 520. The WUS configuration table 700 may include 256 configurations that are indexed 710 from 0 to 255, e.g., 256 combinations of 8 bits of the pdcch-ConfigSIB1 field 520. Each of these indexes may refer to specific values for each of the parameters for the WUS configuration, e.g., timing offset O_{WUS} 720, frequency offset R_{WUS} 730, preamble format 740, total number of WUS preambles 750, root sequence and cyclic shift 760, SIB1 monitoring window 770 and maximum number of preamble transmissions 780. Each of these parameters were described above.

The WUS configuration table 700 may include the 256 most common configurations for the WUS. This table may be indicated to the UE 110, e.g., via radio resource control (RRC) signaling or Medium Access Control Control Element (MAC-CE) signaling when the UE 110 is in communication with the network or may be hard coded in the standards, e.g., the 3GPP Technical Specifications. The pdcch-ConfigSIB1 field 520 may signal one of the 256 configurations and the UE 110 may then select the correct one of the WUS configurations from the WUS configuration table 700 and transit the WUS according to the selected configuration.

The WUS configuration table 700 is only an example and there is no requirement that all the columns shown in FIG. 7 be provided. Furthermore, other columns with different WUS configuration information may also be provided. In addition, not all 256 rows need to be populated, e.g., some indexes 710 may be reserved for future use.

The above provided examples of the UE 110 being configured to understand that the base station 300 is operating in NES mode and the UE 110 may trigger on-demand SSBs or SIB1 and also the configuration of the WUS that the UE 110 may send to trigger the on-demand SSBs or SIB1. The following provides examples of UE 110 operation after the UE 110 sends the WUS, e.g., how should the UE 110 monitor for the on-demand SSBs or SIB1.

After the UE 110 sends the WUS, the UE 110 may start the SIB1 monitoring window. The starting time of the window and UE 110 monitoring behavior within the window may depend on whether the CORESET #0 and the search space zero configurations are indicated in MIB. The following will provide two examples based on these considerations.

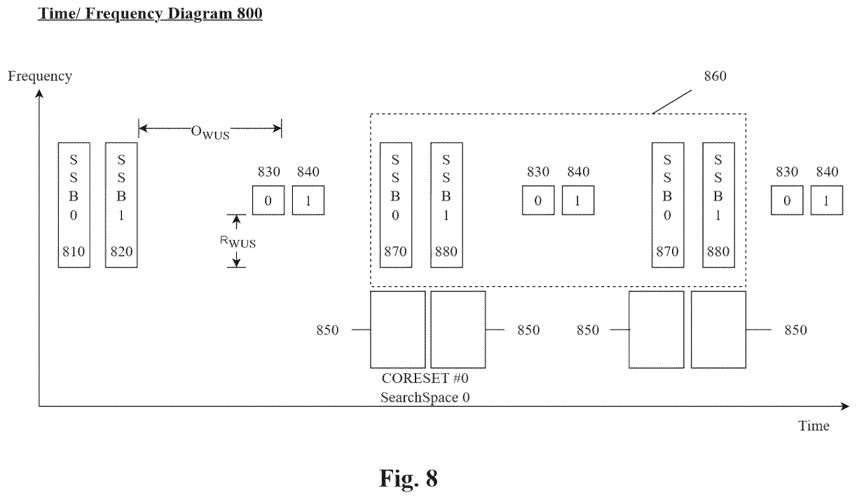

FIG. 8 shows a timing and frequency diagram 800 illustrating a first example of a SIB1 monitoring window according to various example embodiments. In this example, the CORESET #0 and the search space zero related information may be indicated to the UE 110 with the WUS configuration, e.g., in the pdcch-ConfigSIB1 field 520 of the MIB 500 of FIG. 5. The CORESET #0 information indicates the number of resource blocks/symbols used to determine the CORESET #0 of the type0 PDCCH Common Search Space (CSS) and the search space 0 information indicates the PDCCH monitoring occasions.

The timing and frequency diagram 800 is similar to the timing and frequency diagram 600 described above with reference to FIG. 6 in that it shows the SSBs 810 and 820 transmitted by the base station 300 and the WUS resources 830 and 840 that may be used by the UE 110 to transit the WUS to trigger the on-demand SSB or SIB1.

In this example, the UE 110 may have sent a WUS using the first WUS resource 840 corresponding to detecting the first SSB1 820. Since the CORESET #0 and search space zero related information are included with the WUS configuration information, the UE 110 may start the SIB1 monitoring window 860 at the first symbol of the earliest CORESET the UE 110 is configured to receive Physical Downlink Control Channel (PDCCH) for Type0-PDCCH Common Search Space (CSS) set, that is at least one symbol after the last symbol of the WUS occasion 840 corresponding to the WUS transmission, where the symbol duration corresponds to the SCS configured in subCarrierSpacingCommon field 550 in the MIB 500.

This is illustrated in FIG. 8 where the SIB1 monitoring window 860 begins at the CORESET #0, search space 0 850 under the assumption that this CORESET #0, search space 0 850 satisfies the conditions described above. The UE 110 may monitor for Downlink Control Information (DCI) Format 1_0 scrambled with System Information-Radio Network Temporary Identifier (SI-RNTI). The UE 110 may continue to monitor for the SIB1 information for the duration of the SIB1 monitoring window 860 as shown by example in FIG. 8.

The SSB0 870 and SSB1 880 that are transmitted by the base station 300 during the SIB1 monitoring window 860 may be different than the SSB0 810 and SSB1 820 transmitted prior to the SIB1 monitoring window 860. For example, since the UE 110 transmitted the WUS in the WUS occasion 840, the base station 300 may have received the WUS and started to transmit on-demand SSBs, e.g., SSBs that include SIB1 information. Thus, the SSB0 870 and SSB1 880 may be on-demand SSBs that include SIB1 information.

In this example, the UE 110 may directly monitor for the DCI format 1_0 scrambled with the SI-RNTI. However, because the CORESET #0 and search space zero information is included with the WUS configuration information, the configuration flexibility of CORESET #0, search space zero and WUS may be impacted.

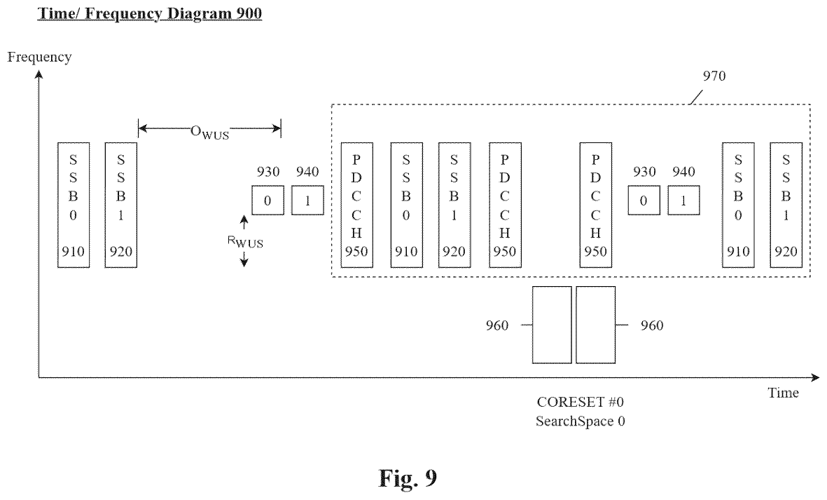

FIG. 9 shows a timing and frequency diagram 900 illustrating a second example of a SIB1 monitoring window according to various example embodiments. In this example, the CORESET #0 and the search space zero related information may be indicated to the UE 110 using the DCI (e.g., PDCCH 950) that the UE 110 monitors in the SIB1 monitoring window 970.

The timing and frequency diagram 900 is similar to the timing and frequency diagram 600 described above with reference to FIG. 6 in that it shows the SSBs 910 and 920 transmitted by the base station 300 and the WUS resources 930 and 940 that may be used by the UE 110 to transit the WUS to trigger the on-demand SSB or SIB1.

In this example, the UE 110 may have sent a WUS using the first WUS resource 940 corresponding to detecting the first SSB1 920. The SIB1 monitoring window 970 starts from the next slot that is at least one symbol after the last symbol of the WUS occasion corresponding to the WUS transmission, where the symbol duration corresponds to the SCS configured in subCarrierSpacingCommon field 550 in the MIB 500. This is illustrated in FIG. 9 where the SIB1 monitoring window 970 begins at the start of the first PDCCH 950 under the assumption that the slot including the first PDCCH 950 satisfies the conditions described above.

The DCI sent on the PDCCH 950 may be a new DCI format that is sent by the base station 300 in response to receiving the WUS. The DCI may be scrambled by the SI-RNTI and may include the two fields of the pdcch-ConfigSIB1 520 to indicate the CORESET and search space that is associated with the on-demand SIB1, e.g., ControlResourceSetZero field 530 and SearchSpaceZero field 540 of the pdcch-ConfigSIB1 520 described above with reference to FIG. 5. In the example of FIG. 9, the DCI configures a CORESET #0 and search space 0 960.

The UE 110 may monitor the CORESET and search space for the new DCI format 950 according to a pre-defined rule. For example, the rule may be that a CORESET with 24 resource blocks (RB) with a center RB aligned with a center RB of the detected SSB, e.g., SSB1 920. In another example, the rule may be that a CORESET with 24 RB with a lower RB aligned with a lower RB of the detected SSB, e.g., SSB1 920. The rules may also include a search space periodicity such as per slot, per 2 slots, per CORESET symbols, e.g., 2 symbols, 3 symbols, etc. The rules described above are only examples and it is possible to define different rules for the monitoring the CORESET #0 and search space 0 960.

In addition to the CORESET and search space information, the DCI in the PDCCH 950 may also include a time duration that may be used to indicate to the UE 110 a length of the SIB1 transmission, e.g., how long the base station will transmit the on-demand SSB or SIB1. If the DCI does not include an indication of the time duration, this may indicate to the UE 110 that there are no CORESET #0 after the SIB1 monitoring window 970 expires.

If the DCI format includes the time duration, this may indicate that the UE 110 may continue to monitor for the on-demand SSB or SIB1 after the SIB1 monitoring window 970 expires. In a first example, the time duration may indicate the monitoring time may be extended for the indicated time duration after the original SIB1 monitoring window 970 expires. In a second example, the time duration may indicate that the monitoring time may be extended for the indicated time duration from the first real CORESET #0, e.g., from the start of CORESET #0 960, which may extend past the SIB1 monitoring window 970.

In this example, there may be more flexibility in scheduling the CORESET #0 and search space zero information because it is carried by the DCI sent in response to receiving the WUS rather than in the WUS configuration as in the above example. Sending this new DCI may result in additional overhead.

### EXAMPLES

In a first example, a method performed by a user equipment (UE), comprising decoding, based on signals received from a base station, configuration information comprising (i) an indication that the base station is not transmitting System Information Block 1 (SIB1) information and (ii) wakeup signal (WUS) configuration information indicating information for sending a WUS to trigger the base station to transmit SIB1 information, configuring transceiver circuitry to transmit the WUS to the base station according to the WUS configuration information and monitoring for SIB1 information transmitted from the base station.

In a second example, the method of the first example, wherein the configuration information is indicated in a Physical Broadcast Channel (PBCH) payload of a Synchronization Signal Block (SSB) transmitted by the base station.

In a third example, the method of the second example, wherein, when the UE is operating in Frequency Range 1 (FR1), the indication that the base station is not transmitting SIB1 information is provided in a ssb-SubcarrierOffset field of a Master Information Block (MIB).

In a fourth example, the method of the second example, wherein, when the UE is operating in Frequency Range 2 (FR2), the indication that the base station is not transmitting SIB1 information is provided in a ssb-SubcarrierOffset field of a Master Information Block (MIB).

In a fifth example, the method of the second example, wherein the WUS configuration information is provided in a pdcch-ConfigSIB1 field of a Master Information Block (MIB).

In a sixth example, the method of the fifth example, wherein the WUS configuration information comprises a timing offset of a WUS resource, wherein the WUS resource is located, in time, the timing offset after the SSB in which the UE detected the WUS configuration information, wherein the WUS is transmitted using the WUS resource.

In a seventh example, the method of the fifth example, wherein the WUS configuration information comprises a frequency offset of a WUS resource, wherein the WUS resource is located, in frequency, the frequency offset from the SSB in which the UE detected the WUS configuration information, wherein the WUS is transmitted using the WUS resource.

In an eighth example, the method of the fifth example, wherein the WUS configuration information comprises an indication of a preamble format for the WUS.

In a ninth example, the method of the fifth example, wherein the WUS configuration information comprises an indication of a total number of WUS preambles, wherein each WUS preamble corresponds to a type of SIB1 information to be triggered, wherein types of SIB1 information comprise a SIB1 transmission, a SSB transmission with SIB1 information or a partial SIB1 transmission.

In a tenth example, the method of the fifth example, wherein the WUS configuration information comprises a root sequence index and cyclic shift for the WUS.

In an eleventh example, the method of the fifth example, wherein the WUS configuration information comprises a SIB1 monitoring window length indicating a length of time for which the UE is to monitor for the SIB1 information after transmitting the WUS.

In a twelfth example, the method of the eleventh example, wherein the configuration information further comprises a Control Resource Set (CORESET) #0 and search space zero information, wherein the SIB1 monitoring window starts at a first symbol of an earliest CORESET the UE is configured to receive a Physical Downlink Control Channel (PDCCH) for Type0-PDCCH Common Search Space (CSS) set that is at least one symbol after a last symbol of a WUS occasion in which the WUS was transmitted, wherein a symbol duration corresponds to a subcarrier spacing (SCS) configured in a subCarrierSpacingCommon field of a Master Information Block (MIB) of the PBCH.

In a thirteenth example, the method of the twelfth example, further comprising monitoring Downlink Control Information (DCI) Format 1_0 scrambled with a System Information—Radio Network Temporary Identifier (SI-RNTI) for the SIB1 information transmitted from the base station.

In a fourteenth example, the method of the eleventh example, further comprising decoding, based on signals received from the base station, downlink control information (DCI) comprising a Control Resource Set (CORESET) #0 and search space zero information for monitoring for the SIB1 information, wherein the DCI is received in a Physical Downlink Control Channel (PDCCH) during the SIB1 monitoring window, wherein the SIB1 monitoring window starts at a next slot that is at least one symbol after a last symbol of a WUS occasion in which the WUS is transmitted, wherein a symbol duration corresponds to a subcarrier spacing (SCS) configured in a subCarrierSpacingCommon field of a Master Information Block (MIB) of the PBCH.

In a fifteenth example, the method of the fourteenth example, wherein the UE monitors on the CORESET #0 and search space zero based on (i) a center resource block (RB) of the CORESET #0 being aligned with a center RB of the SSB in which the UE detected the WUS configuration information or (ii) a lowest RB of the CORESET #0 being aligned with a lowest RB of the SSB in which the UE detected the WUS configuration information.

In a sixteenth example, the method of the fourteenth example, wherein the UE monitors on the CORESET #0 and search space zero based on a search space periodicity of (i) per slot, (ii) per 2 slots (iii) per 2 CORESET symbols, or (iv) per 3 CORESET symbols.

In a seventeenth example, the method of the fourteenth example, wherein the DCI further comprises a time duration indicating a time after the SIB1 monitoring window expires during which the UE continues to monitor for SIB1 information, wherein the time duration is measured from (i) a time the SIB1 monitoring window expires or (ii) a time from a first CORESET #0 in the SIB1 monitoring window.

In an eighteenth example, the method of the fifth example, wherein the WUS configuration information comprises transmission power information for the WUS.

In an nineteenth example, the method of the fifth example, wherein the WUS configuration information comprises a maximum number of WUS transmissions for the WUS.

In a twentieth example, the method of the fifth example, wherein the UE is preconfigured with a table comprising a plurality of WUS configuration information, wherein the WUS configuration information provided in the pdcch-ConfigSIB1 field of the MIB indicates one of the plurality of WUS configuration information.

In an twenty first example, the method of the second example, wherein the WUS is transmitted in a WUS resource (i) having a lowest Physical Resource Block (PRB) aligned with a lowest PRB of the SSB in which the UE detected the WUS configuration information, (ii) having a highest PRB aligned with a highest PRB of the SSB in which the UE detected the WUS configuration information or (iii) having a center PRB aligned with a center PRB of the SSB in which the UE detected the WUS configuration information.

In an twenty second example, the method of the first example, wherein the WUS is transmitted using a predefined preamble format, wherein the predefined format comprises FR1 Format 0 or FR2 Format B4.

In an twenty third example, the method of the first example, wherein a total number of WUS preambles to be transmitted by the UE is predefined.

In an twenty fourth example, the method of the first example, wherein the WUS is transmitted at a maximum UE transmission power.

In a twenty fifth example, a processor configured to perform any of the methods of the first through twenty fourth examples.

In a twenty sixth example, a user equipment comprising a transceiver configured to communicate with a base station and a processor communicatively coupled to the transceiver and configured to perform any of the methods of the first through twenty fourth examples.

In a twenty seventh example, a method performed by a base station, comprising configuring transceiver circuitry to transmit configuration information to a user equipment (UE) comprising (i) an indication that the base station is not transmitting System Information Block 1 (SIB1) information and (ii) wakeup signal (WUS) configuration information indicating information for sending a WUS to trigger the base station to transmit SIB1 information, decoding, based on signals received from the UE, the WUS and configuring transceiver circuitry to transmit SIB1 information.

In a twenty eighth example, the method of the twenty seventh example, wherein the configuration information is indicated in a Physical Broadcast Channel (PBCH) payload of a Synchronization Signal Block (SSB) transmitted by the base station.

In a twenty ninth example, the method of the twenty eighth example, wherein, when the UE is operating in Frequency Range 1 (FR1), the indication that the base station is not transmitting SIB1 information is provided in a ssb-SubcarrierOffset field of a Master Information Block (MIB).

In a thirtieth example, the method of the twenty eighth example, wherein, when the UE is operating in Frequency Range 2 (FR2), the indication that the base station is not transmitting SIB1 information is provided in a ssb-SubcarrierOffset field of a Master Information Block (MIB).

In a thirty first example, the method of the twenty eighth example, wherein the WUS configuration information is provided in a pdcch-ConfigSIB1 field of a Master Information Block (MIB).

In a thirty second example, the method of the thirty first example, wherein the WUS configuration information comprises a timing offset of a WUS resource, wherein the WUS resource is located, in time, the timing offset after the SSB in which the UE detected the WUS configuration information, wherein the WUS is transmitted using the WUS resource.

In a thirty third example, the method of the thirty first example, wherein the WUS configuration information comprises a frequency offset of a WUS resource, wherein the WUS resource is located, in frequency, the frequency offset from the SSB in which the UE detected the WUS configuration information, wherein the WUS is transmitted using the WUS resource.

In a thirty fourth example, the method of the thirty first example, wherein the WUS configuration information comprises an indication of a preamble format for the WUS.

In a thirty fifth example, the method of the thirty first example, wherein the WUS configuration information comprises an indication of a total number of WUS preambles, wherein each WUS preamble corresponds to a type of SIB1 information to be triggered, wherein types of SIB1 information comprise a SIB1 transmission, a SSB transmission with SIB1 information or a partial SIB1 transmission.

In a thirty sixth example, the method of the thirty first example, wherein the WUS configuration information comprises a root sequence index and cyclic shift for the WUS.

In a thirty seventh example, the method of the thirty first example, wherein the WUS configuration information comprises a SIB1 monitoring window length indicating a length of time for which the UE is to monitor for the SIB1 information after transmitting the WUS.

In a thirty eighth example, the method of the thirty seventh example, wherein the configuration information further comprises a Control Resource Set (CORESET) #0 and search space zero information, wherein the SIB1 monitoring window starts at a first symbol of an earliest CORESET the UE is configured to receive a Physical Downlink Control Channel (PDCCH) for Type0-PDCCH Common Search Space (CSS) set that is at least one symbol after a last symbol of a WUS occasion in which the WUS was transmitted, wherein a symbol duration corresponds to a subcarrier spacing (SCS) configured in a subCarrierSpacingCommon field of a Master Information Block (MIB) of the PBCH.

In a thirty ninth example, the method of the thirty eighth example, further comprising configuring transceiver circuity to transmit Downlink Control Information (DCI) Format 1_0 scrambled with a System Information—Radio Network Temporary Identifier (SI-RNTI) comprising the SIB1 information.

In a forty first example, the method of the thirty eighth example, further comprising configuring transceiver circuity to transmit downlink control information (DCI) comprising a Control Resource Set (CORESET) #0 and search space zero information for monitoring for the SIB1 information, wherein the DCI is transmitted in a Physical Downlink Control Channel (PDCCH) during the SIB1 monitoring window, wherein the SIB1 monitoring window starts at a next slot that is at least one symbol after a last symbol of a WUS occasion in which the WUS is transmitted, wherein a symbol duration corresponds to a subcarrier spacing (SCS) configured in a subCarrierSpacingCommon field of a Master Information Block (MIB) of the PBCH.

In a forty second example, the method of the forty first example, wherein the DCI further comprises a time duration indicating a time after the SIB1 monitoring window expires during which the UE continues to monitor for SIB1 information, wherein the time duration is measured from (i) a time the SIB1 monitoring window expires or (ii) a time from a first CORESET #0 in the SIB1 monitoring window.

In a forty third example, the method of the thirty first example, wherein the WUS configuration information comprises transmission power information for the WUS.

In a forty fourth example, the method of the thirty first example, wherein the WUS configuration information comprises a maximum number of WUS transmissions for the WUS.

In a forty fifth example, the method of the thirty first example, wherein the UE is preconfigured with a table comprising a plurality of WUS configuration information, wherein the WUS configuration information provided in the pdcchConfigSIB1 field of the MIB indicates one of the plurality of WUS configuration information.

In a forty sixth example, a processor configured to perform any of the methods of the twenty seventh through forty fifth examples.

In a forty seventh example, a base station comprising a transceiver configured to communicate with a user equipment and a processor communicatively coupled to the transceiver and configured to perform any of the methods of the twenty seventh through forty fifth examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus of a user equipment (UE), the apparatus comprising processing circuitry configured to:
decode, based on signals received from a base station, configuration information comprising (i) an indication that the base station is not transmitting System Information Block 1 (SIB1) information and (ii) wakeup signal (WUS) configuration information indicating information for sending a WUS to trigger the base station to transmit SIB1 information;
configure transceiver circuitry to transmit the WUS to the base station according to the WUS configuration information; and
monitor for SIB1 information transmitted from the base station.

2. The apparatus of claim 1, wherein the configuration information is indicated in a Physical Broadcast Channel (PBCH) payload of a Synchronization Signal Block (SSB) transmitted by the base station.

3. The apparatus of claim 2, wherein, when the UE is operating in Frequency Range 1 (FR1), the indication that the base station is not transmitting SIB1 information is provided in a ssb-SubcarrierOffset field of a Master Information Block (MIB).

4. The apparatus of claim 2, wherein, when the UE is operating in Frequency Range 2 (FR2), the indication that the base station is not transmitting SIB1 information is provided in a ssb-SubcarrierOffset field of a Master Information Block (MIB).

5. The apparatus of claim 2, wherein the WUS configuration information is provided in a pdcch-ConfigSIB1 field of a Master Information Block (MIB).

6. The apparatus of claim 5, wherein the WUS configuration information comprises a timing offset of a WUS resource, wherein the WUS resource is located, in time, the timing offset after the SSB in which the UE detected the WUS configuration information, wherein the WUS is transmitted using the WUS resource.

7. The apparatus of claim 5, wherein the WUS configuration information comprises a frequency offset of a WUS resource, wherein the WUS resource is located, in frequency, the frequency offset from the SSB in which the UE detected the WUS configuration information, wherein the WUS is transmitted using the WUS resource.

8. The apparatus of claim 5, wherein the WUS configuration information comprises an indication of a preamble format for the WUS.

9. The apparatus of claim 5, wherein the WUS configuration information comprises an indication of a total number of WUS preambles, wherein each WUS preamble corresponds to a type of SIB1 information to be triggered, wherein types of SIB1 information comprise a SIB1 transmission, a SSB transmission with SIB1 information or a partial SIB1 transmission.

10. The apparatus of claim 5, wherein the WUS configuration information comprises a root sequence index and cyclic shift for the WUS.

11. The apparatus of claim 5, wherein the WUS configuration information comprises a SIB1 monitoring window length indicating a length of time for which the UE is to monitor for the SIB1 information after transmitting the WUS.

12. The apparatus of claim 11, wherein the configuration information further comprises a Control Resource Set (CORESET) #0 and search space zero information, wherein the SIB1 monitoring window starts at a first symbol of an earliest CORESET the UE is configured to receive a Physical Downlink Control Channel (PDCCH) for Type0-PDCCH Common Search Space (CSS) set that is at least one symbol after a last symbol of a WUS occasion in which the WUS was transmitted, wherein a symbol duration corresponds to a subcarrier spacing (SCS) configured in a subCarrierSpacingCommon field of a Master Information Block (MIB) of the PBCH.

13. The apparatus of claim 12, wherein the processing circuitry is further configured to monitors Downlink Control Information (DCI) Format 1_0 scrambled with a System Information-Radio Network Temporary Identifier (SI-RNTI) for the SIB1 information transmitted from the base station.

14. The apparatus of claim 11, wherein the processing circuitry is further configured to:
decode, based on signals received from the base station, downlink control information (DCI) comprising a Control Resource Set (CORESET) #0 and search space zero information for monitoring for the SIB1 information, wherein the DCI is received in a Physical Downlink Control Channel (PDCCH) during the SIB1 monitoring window, wherein the SIB1 monitoring window starts at a next slot that is at least one symbol after a last symbol of a WUS occasion in which the WUS is transmitted, wherein a symbol duration corresponds to a subcarrier spacing (SCS) configured in a subCarrierSpacingCommon field of a Master Information Block (MIB) of the PBCH.

15. The apparatus of claim 14, wherein the UE monitors on the CORESET #0 and search space zero based on (i) a center resource block (RB) of the CORESET #0 being aligned with a center RB of the SSB in which the UE detected the WUS configuration information or (ii) a lowest RB of the CORESET #0 being aligned with a lowest RB of the SSB in which the UE detected the WUS configuration information.

16. The apparatus of claim 14, wherein the UE monitors on the CORESET #0 and search space zero based on a search space periodicity of (i) per slot, (ii) per 2 slots (iii) per 2 CORESET symbols, or (iv) per 3 CORESET symbols.

17. The apparatus of claim 14, wherein the DCI further comprises a time duration indicating a time after the SIB1 monitoring window expires during which the UE continues to monitor for SIB1 information, wherein the time duration is measured from (i) a time the SIB1 monitoring window expires or (ii) a time from a first CORESET #0 in the SIB1 monitoring window.

18. The apparatus of claim 5, wherein the WUS configuration information comprises transmission power information for the WUS.

19. The apparatus of claim 5, wherein the WUS configuration information comprises a maximum number of WUS transmissions for the WUS.

20. The apparatus of claim 5, wherein the UE is preconfigured with a table comprising a plurality of WUS configuration information, wherein the WUS configuration information provided in the pdcch-ConfigSIB1 field of the MIB indicates one of the plurality of WUS configuration information.
